(19) United States
(12) Patent Application Publication
(10) Pub. No.: US 2016/0142745 A1
(43) Pub. Date: May 19, 2016

(54) MANAGEMENT SYSTEM TO PREDICT SIGNAL STRENGTH AND BIT RATE

(71) Applicant: KBA2 INC., San Francisco, CA (US)

(72) Inventors: Jon B. FISHER, San Francisco, CA (US); James A. REDFIELD, Boise, ID (US); Richard G. SMITH, Lynnwood, WA (US); Austin A. MARKUS, San Francisco, CA (US); Bryan GREEN, West Sacramento, CA (US); Steven L. HARRIS, Perris, CA (US)

(21) Appl. No.: 14/859,172

(22) Filed: Sep. 18, 2015

Related U.S. Application Data
(60) Provisional application No. 62/081,494, filed on Nov. 18, 2014.

(51) Int. Cl. H04N 21/2381; H04N 21/61; H04N 21/647; H04N 21/433; H04N 21/234; H04W 4/02; H04N 21/2187

(52) U.S. Cl. CPC H04N 21/2381; H04W 4/027; H04N 21/6181; H04N 21/2187; H04N 21/4334; H04N 21/23406; H04N 21/64738

(57) ABSTRACT

The present invention relates to a system and method for adjusting bit rate streaming during live video recording while traveling in a moving vehicle on public right-of-ways. The embodiments of the present invention relates to a system and method for gathering and analyzing dynamically and continuously cellular strength and bit loss while traveling from point A to point B. The result of the predictive bit rate is to adjust the video streaming throughput to best match the predictive bit rate and maximize the quality of the video stream.

This application claims the benefit of application No. 62/081,494 filed Nov. 18, 2014, the entire content of which is expressly incorporated herein by reference thereto.

### FIELD OF INVENTION

The present invention relates to a system and method for adjusting bit rate streaming during live video recording while traveling in a moving vehicle on public right-of-ways. The embodiments of the present invention relates to a system and method for gathering and analyzing dynamically and continuously cellular strength and bit loss while traveling from point A to point B. The result of the predictive bit rate is to adjust the video streaming throughput to best match the predictive bit rate and maximize the quality of the video stream.

### BACKGROUND OF THE INVENTION

Mobile device connections to the internet via cellular and Wi-Fi are difficult to manage especially in a moving vehicle making live video streaming while moving difficult. Video streaming in such environments is dependent on the best signal while transitioning along fixed paths. One way to obtain the best signal is to degrade and upgrade the frame rate as the bit rate decreases or increases. Using the present models and an accumulated knowledge base the present invention can now accurately predict when and where streaming environments may be poor or excellent.

### SUMMARY OF THE INVENTION

The invention relates to methods and systems for adjusting bit rate streaming during live video recording while traveling in a moving vehicle on public right-of-ways are described.

In accordance with the principles of the present invention, a mobile audio video system is provided. The system generally comprises a recording device with circuitry to capture audio and video; a first database that continuously records and updates parameter changes, including cellular signal strength of all carriers, GPS coordinates, speed of movement, and direction of movement; a second database that records location, elevation, and strength of signal of all telecommunication devices throughout an area of interest; a first software system on a mobile device; and a communication component comprising a server that contains a second software system and that is configured to provide associated services with the recording device based on information stored in the first and second databases and processed by the first software system, the associated services predict signal strength and automatically adjust bit rate of the recording device to insure maximum quality of video stream during transmission from the mobile device of an event of interest.

In the above system, the recording device, the first software system, and the mobile device generate relevant metadata for one of the databases while streaming the video of the event and moving through space over time.

In the above system, the metadata comprises position of user, travel speed of user, distance to nearest signal, strength of three strongest signals in vicinity, provider of signal, time and date of the video of the event. The recording device, the first software system, and the mobile device may further generate video assets based on the video, the video of the event, the metadata for the video, and the metadata for the video of the event.

The video assets comprise video highlights of a day, a thumbnail video of user's experiences throughout a day, a compilation of all the metadata throughout a day, or a combination thereof. Also, the server is configured for providing associated services comprises a dashboard interface that is operable by a director and provides the director access to shared videos or metadata. The director can create a representative video of the event using the shared videos or metadata. The video may be a single visual image, a series of visual images, or a combination of one or more visual images and audio.

In the above system, the event of interest is typically a sporting event, a concert, an emergency situation, a spontaneous event that arises in everyday life, or any event in which user has interest.

In accordance with the principles of the present invention, a mobile device may also be provided. The device comprises a recording device having circuitry that captures video communications and that is configured to provide personal voice or data communications over a wireless network; a processor, transient memory, and non-transient memory; and a software application resident on the mobile device that is executed by the processor and is configured to automatically store video from the recording device in a buffer in the transient memory without a user selecting to record video using the recording device, wherein the software application transmits, over the wireless network, video from the buffer to a server configured for providing an associated service when the user selects to record video using the recording device.

A system may be included that comprises a server that comprises network communication components over which the server receives buffered and recorded video from various mobile devices and that is configured to combine individual buffered video with recorded video from the same mobile device to form a single video asset for a user, the server is further configured to store the assets in a database and transmit the assets over a network.

An alternative system includes a server comprising communications components over which the server receives video and individually associated metadata and comprising a processor and associated memory that is configured to process the metadata and to display the trends to a user of the system and is further configured to allow the user of the system to select specific buffered and recorded content associated with a particular trend to combine into a video asset capturing a visual event associated with the trend.

The invention also includes a method of determining for a vehicle traversing a streaming area an optimum travel route from point A to point B. The optimum travel route can include the route having the best travel, the fastest travel, or the most complete cellular coverage or a route that combines one or more of the foregoing, and the method comprises predicting or projecting the route based on predictive bit rate management.

In the above method, the predictive bit rate management is preferably provided on the mobile device from the mobile audio video system described above.

A communication system that predicts best vehicle routes for traversing a landscape throughout an area of interest may also be provided. The prediction may be based on desired outcomes including routes through the area having the best travel, the fastest travel, or the most complete cellular coverage or a route that combines one or more of the foregoing, which comprises predicting or projecting the route based on predictive bit rate management provided on the mobile device from the mobile audio video system described above.

### DETAILED DESCRIPTION OF THE INVENTION

Predictive Streaming helps systems stream the highest quality video and audio while moving through an environment. As a user streams video and audio, the software running on a device optimizes the video and audio stream quality, based on the predicted video and audio streaming potential along its probable pathways.

As the device system travels it collects device metrics and network connectivity data, and receives predictive performance data for the surrounding geographic area. The device metrics and network connectivity data it collects include, but is not limited to: GPS location, upstream bit-rate, downstream bit-rate, data packet loss, device temperature, stream initiation timestamp, battery charge, and authenticated user information. The predictive performance data the device receives includes, but is not limited to: the predicted video and audio streaming performance data by location, predicted streaming performance heat map, and the recommended user pathways to take based on the predicted video and audio stream performance.

During transit, the software running on the streaming device analyzes the predictive performance data and automatically optimizes the video and audio streams, and generates notifications to assist the user. Some of the ways the software optimizes the video and audio streams are: adjusting the upstream bit-rate, adjusting compression, adjusting video resolution, adjusting video frame rate, and changing codecs. Some of the methods the software uses to notify the user are: visual cues in the device display, audio cues through the device speakers, and physical cues through the device vibration feature. The software helps the user make routing decisions based on streaming performance, and automatically optimizes the video and audio quality during transit.

Predictive bit rate adjustment is a model that manages video bit rate using a knowledge based system including location, direction, speed, current prediction, and transport routes, and cellular coverage maps.

A traditional adaptive bit rate solution reacts to dropped packets to adjust the bit rate down. However, if we start with a traditional scheme and record the location of all bit rate adjustments we can then use that data to scale the bit rate down of other users before they get to the bad area.

While useful for scaling down, it is even more useful if you know that you are leaving an area of bad coverage and entering a good one. You could automatically adjust the bit rate up. Otherwise you are forced to try to up the bit rate regularly, probing the connection, in order to get the stream to upgrade. This will cause stream errors if you are in and are staying in an area of poor coverage, as each time it tries it will fail and will have to drop back down.

Of course there will still need to be some probing to discover network upgrades and fixes, and it will be carrier specific, but it should help dramatically with the app's decision making

Probing could consist of two streams.
Stream 1=a normal stream that we use today; and
Stream 2=a test stream, that probes the connection bandwidth on a more controlled basis. This probe would be at a very low bandwidth and used to make decisions about higher bandwidth needs—a formula involving signal strength and so on. This probe should be a proprietary black box.

The above described methods and systems may involve a database, a mobile device, a server device, a communication system, a software system, and any combinations thereof. All these components, as appreciated by those skilled the art, can take many forms capable of operating the present invention. Additionally, as also appreciated by those skilled in the art, all these components can perform interconnected and distributed functions. In a preferred embodiment, each component may comprise control circuitry, storage, memory, input/output (“I/O”) circuitry, communications circuitry, a display, or any combinations thereof. As appreciated by those skilled in the art, each component may further include other computer parts not mentioned above, e.g., a power supply, an input mechanism, etc.

Control circuitry can include any processing circuitry or processor operative to control the operations and performance of each component. For example, control circuitry can be used to run operating system applications, firmware applications, software systems, or other applications used to communicate with users and other components of the present invention. Control circuitry can drive the display and process inputs received from a user interface, e.g., the display if it is a touch screen.

Storage can include, for example, one or more tangible computer storage devices including a hard-drive, solid state drive, flash memory, permanent memory such as ROM, magnetic, optical, semiconductor, or any other suitable type of storage component, or any combination thereof. Storage can store, for example, application data for implementing functions on each component, authentication information such as libraries of data associated with authorized users, streaming video data such as video content and time and date of the users watch the video, wireless connection data that can enable each component to establish a wireless connection, and any other suitable data or any combination thereof. The instructions for implementing the functions of the present invention may, as non-limiting examples, comprise non transient software and/or scripts stored in a computer-readable media. The storage may be the utilized as a database.

Memory can include cache memory, semi-permanent memory such as RAM, and/or one or more types of memory used for temporarily storing data. In some embodiments, memory can also be used for storing data to operate each component, or any other data from storage. In some embodiments, memory and storage can be combined as a single storage medium. The memory may also be used as a database.

I/O circuitry can be operative to convert and encode/decode analog signals and other signals into digital data. In some embodiments, I/O circuitry can also convert digital data into another type of signal, and vice-versa. For example, I/O circuitry can receive and convert physical contact inputs from a multi-touch screen such as display, physical movements from a mouse or sensor, analog audio signals from a microphone, or other input. The digital data can be provided to and received from control circuitry, storage, and memory, or any other components. One or more instances of I/O circuitry can be included each component.

Each component can include any suitable interface or component for allowing a user to provide inputs to I/O circuitry. For example, each component can include a button, keypad, dial, a click wheel, or a touch screen, e.g., display.

Display includes the display and display circuitry for providing a display visible to the user. For example, the display circuitry can include a screen, e.g., an LCD screen, that is incorporated in each component. In some embodiments, the display circuitry can include a coder/decoder (Codec) to convert digital data into analog signals and vice versa. For example, the display circuitry or other appropriate circuitry within each component can include Codecs necessary to process video being streamed and the associated data, or any other suitable type of Codec.

The display circuitry also can include display driver circuitry, circuitry for driving display drivers, or both. The display circuitry can be operative to display content, e.g., application screens for applications implemented on each component, information regarding ongoing communications operations, information regarding incoming communications requests, or device operation screens, under the direction of control circuitry. Alternatively, the display circuitry can be operative to provide instructions to a remote display.

Communications circuitry can include any suitable communications circuitry operative to connect to a communications network and to transmit communications, e.g., data from each component to other components or computers within the communications network. Communications circuitry can be operative to interface with a communications network using any suitable communications protocol such as Wi-Fi, 802.11, Bluetooth, radio frequency systems such as 900 MHz, 1.4 GHz, and 5.6 GHz communication systems, infrared, GSM, GSM plus EDGE, CDMA, quadband, and other cellular protocols, VOIP, or any other suitable protocol. The communications network may also be established by using wires such as an optical fiber or Ethernet cable. The communications circuitry may be utilized as the communication system.

Each component or the communication system can include one or more instances of communications circuitry for simultaneously performing several communications operations using different communications networks. For example, each component can include a first instance of communications circuitry for communicating over a cellular network, a second instance of communications circuitry for communicating over Wi-Fi or using Bluetooth, and a third instance of communications circuitry for communicating over an optical fiber. In some embodiments, the same instance of communications circuitry can be operative to provide for communications over several communications networks.

What is claimed is:

1. A mobile audio video system comprising:
a recording device with circuitry to capture audio and video;
a first database that continuously records and updates parameter changes, including cellular signal strength of all carriers, GPS coordinates, speed of movement, and direction of movement;
a second database that records location, elevation, and strength of signal of all telecommunication devices throughout an area of interest;
a first software system on a mobile device; and
a communication component comprising a server that contains a second software system and that is configured to provide associated services with the recording device based on information stored in the first and second databases and processed by the first software system, the associated services predict signal strength and automatically adjust bit rate of the recording device to insure maximum quality of video stream during transmission from the mobile device of an event of interest.

2. The system of claim 1, where the recording device, the first software system, and the mobile device generate relevant metadata for one of the databases while streaming the video of the event and moving through space over time.

3. The system of claim 2, wherein the metadata comprises position of user, travel speed of user, distance to nearest signal, strength of three strongest signals in vicinity, provider of signal, time and date of the video of the event.

4. The system of claim 3, where the recording device, the first software system, and the mobile device further generate video assets based on the video, the video of the event, the metadata for the video, and the metadata for the video of the event.

5. The system of claim 4, wherein the video assets comprise video highlights of a day, a thumbnail video of user's experiences throughout a day, a compilation of all the metadata throughout a day, or a combination thereof.

6. The system of claim 5, wherein the server configured for providing associated services comprises a dashboard interface that is operable by a director and provides the director access to shared videos or metadata.

7. The system of claim 6, wherein the director creates a representative video of the event using the shared videos or metadata.

8. The system of claim 1, wherein the video is a single visual image, a series of visual images, or a combination of one or more visual images and audio.

9. The system of claim 1, wherein the event of interest is a sporting event, a concert, an emergency situation, a spontaneous event that arises in everyday life, or any event in which user has interest.

10. The system of claim 1 wherein the mobile device comprises:
the recording device with circuitry that captures video communications and that is configured to provide personal voice or data communications over a wireless network; and
a processor, transient memory, and non-transient memory;
wherein the software comprises a software application resident on the mobile device that is executed by the processor and is configured to automatically store video from the recording device in a buffer in the transient memory without a user selecting to record video using the recording device, wherein the software application transmits, over the wireless network, video from the buffer to a server configured for providing an associated service when the user selects to record video using the recording device.

11. The system of claim 1 wherein the server comprises network communication components over which the server receives buffered and recorded video from various mobile devices with the server configured to combine individual buffered video with recorded video from the same mobile device to form a single video asset for a user, the server is further configured to store the assets in a database and transmit the assets over a network.

12. The system of claim 1 wherein the server comprises communications components over which the server receives video and individually associated metadata and comprising a processor and associated memory that is configured to process the metadata and to display the trends to a user of the system and is further configured to allow the user of the system to select specific buffered and recorded content associated with a particular trend to combine into a video asset capturing a visual event associated with the trend.

13. A method of determining for a vehicle traversing a streaming area an optimum travel route from point A to point B, wherein the optimum travel route includes the route having the best travel, the fastest travel, or the most complete cellular coverage or a route that combines one or more of the foregoing, which comprises predicting or projecting the route based on predictive bit rate management.

14. The method of claim 13 wherein the predictive bit rate management is provided on a mobile device that comprises:
a recording device with circuitry that captures video communications and that is configured to provide personal voice or data communications over a wireless network;
a processor, transient memory, and non-transient memory; and
a software application resident on the mobile device that is executed by the processor and is configured to automatically store video from the recording device in a buffer in the transient memory without a user selecting to record video using the recording device, wherein the software application transmits, over the wireless network, video from the buffer to a server configured for providing an associated service when the user selects to record video using the recording device.

15. A communication system that predicts best vehicle routes for traversing a landscape throughout an area of interest based on desired outcomes including routes through the area having the best travel, the fastest travel, or the most complete cellular coverage or a route that combines one or more of the foregoing, which comprises predicting or projecting the route based on predictive bit rate management provided by the system of claim 10.

16. A system comprising one of:
a server that comprises network communication components over which the server receives buffered and recorded video from various mobile devices and that is configured to combine individual buffered video with recorded video from the same mobile device to form a single video asset for a user, the server is further configured to store the assets in a database and transmit the assets over a network; or
a server comprising communications components over which the server receives video and individually associated metadata and comprising a processor and associated memory that is configured to process the metadata and to display the trends to a user of the system and is further configured to allow the user of the system to select specific buffered and recorded content associated with a particular trend to combine into a video asset capturing a visual event associated with the trend.

17. The system of claim 16 comprising the server that comprises network communication components over which the server receives buffered and recorded video from various mobile devices and that is configured to combine individual buffered video with recorded video from the same mobile device to form a single video asset for a user, the server is further configured to store the assets in a database and transmit the assets over a network.

18. The system of claim 16 comprising the server that comprises the communications components over which the server receives video and individually associated metadata and comprising a processor and associated memory that is configured to process the metadata and to display the trends to a user of the system and is further configured to allow the user of the system to select specific buffered and recorded content associated with a particular trend to combine into a video asset capturing a visual event associated with the trend.
